(19) United States
(12) Patent Application Publication
(10) Pub. No.: US 2016/0380440 A1
(43) Pub. Date: Dec. 29, 2016

(54) ELECTRIC CHARGING POWER MANAGEMENT

(71) Applicant: TEQ Charging, Inc., Marietta, GA (US)

(72) Inventors: James Dorrier Coleman, JR., Atlanta, GA (US); Isaac David Wittenstein, Marietta, GA (US); Joshua Seth Lieberman, Boca Raton, FL (US)

(21) Appl. No.: 15/190,910

(22) Filed: Jun. 23, 2016

Related U.S. Application Data
(60) Provisional application No. 62/185,438, filed on Jun. 26, 2015.

(51) Int. Cl. H02J 7/00; G05F 1/66

(52) U.S. Cl. CPC H02J 7/007; H02J 7/0052; G05F 1/66; G05B 2219/25371

(57) ABSTRACT

Power management systems and methods are used to charge batteries and battery-powered devices over an allotted period of time. A finite amount of source power is allocated and distributed across multiple devices according to a schedule. Users submit requests for time slots in the schedule. For example, a charging platform for electric vehicles can prioritize recharging vehicles that have impending departure times and defer recharging vehicles that are expected to remain present longer.

### CROSS-REFERENCE To RELATED PATENT APPLICATIONS

This application is a non-provisional utility application claiming priority to U.S. Provisional Application No. 62/185,438, titled “Queuing Electric Vehicle Charging,” filed on Jun. 26, 2015, the entirety of which is incorporated herein by reference.

### BACKGROUND

An electrical battery is a device that stores an electrical charge, e.g., by leveraging chemical properties of materials used in a series of electrochemical cells. As an electrical battery is discharged, the chemical state of these materials is altered, releasing the stored charge. A rechargeable battery uses materials that, when subjected to the right conditions, can reverse this alteration, allowing the battery to store an electrical charge.

Many devices use rechargeable batteries. Some such battery-operated devices may have removable or replaceable batteries that can be charged separately from the device. Some battery-operated device may allow the battery to be recharged without removing the battery from the device. For example, the device may include a power-input port to which a cable can be connected to provide power. The cable may connect to a transformer_{;} an electronic device regulating power flow for recharging, or to another power source such as the power grid or another battery. Some devices allow for “wireless” charging in which an external charger induces a current in an internal element of the device without requiring a direct conductive connection to the device.

### SUMMARY

In some aspects, the disclosure relates to a power management system. The system includes a processor configured to execute a set of instructions, a link to a power supply, and a set of branches, each branch configured to selectively provide power from the link to one or more rechargeable devices responsive to control from the processor. The set of instructions, when executed by the processor, cause the processor to: receive a request to provide electrical power to a rechargeable device including a rechargeable battery; determine a set of charging parameters responsive to the request, the set of charging parameters indicating a length of time over which to provide the requested electrical power and an amount of electrical power to provide; identify an electrical resource available for a block of time compatible with the set of charging parameters, the identified electrical resource including a branch in the set of branches; and issue one or more control instructions to route electrical power from the power supply via the identified electrical resource to the rechargeable device during the block of time responsive to the request.

In some implementations of the system, the request specifies a charge value. The set of instructions, when executed by the processor, cause the processor to identify, from the charge value, a minimum length of time needed at a first electrical current level. In some such implementations, the charge value is a battery capacity percentage. In some implementations, the electrical resource available has a maximum available electrical current level lower than the first electrical current level, and the set of instructions, when executed by the processor, cause the processor to identify a second electrical resource available for a second block of time compatible with the set of charging parameters. In some implementations of the system, the set of instructions, when executed by the processor, cause the processor to detect a charge value based on one or more signals from the rechargeable device, and identify, from the detected charge value, a minimum length of time needed at a first electrical current level.

In some implementations of the system, the set of instructions, when executed by the processor, cause the processor to: evaluate the request to determine whether the request can be fully satisfied; place the request in a queue responsive to determining that the request cannot be fully satisfied; periodically reevaluate one or more requests in the queue; and remove the request from the queue responsive to determining that the request can be satisfied. In some implementations, the set of instructions, when executed by the processor, cause the processor to reorder the queue.

In some implementations of the system, the set of charging parameters indicates an anticipated disconnect time representing a point in time by which the request should be satisfied. In some implementations, the rechargeable device includes an electric vehicle charger.

In some implementations of the system, the rechargeable device is a first battery charger in a plurality of battery chargers, and the set of instructions, when executed by the processor, cause the processor to: maintain one or more data structures with data representative of the plurality of battery chargers, the data indicating a respective set of charging parameters for each respective battery charger in the plurality of battery chargers; generate a graph comprising node data and edge data, the node data including a first set of nodes representing the plurality of battery chargers and a second set of nodes representing power supply resources each capable of providing power to one or more battery chargers in the plurality of battery chargers, and the edge data including a set of edges each linking a first respective node from the first set of nodes to a second respective node from the second set of nodes; identify a set of paths through the graph, each path including: a first node from the first set of nodes, a second node from the second set of nodes, and an edge from the set of edges; determine, based on the set of paths through the graph, an allocation of power from the power supply resources to one or more of the plurality of battery chargers, wherein the allocation provides a minimum power level to the first battery charger; and issue the one or more control instructions to route electrical power from the power supply to the battery charger in accordance with the determined allocation.

In some aspects, the disclosure relates to a method of allocating electrical power in a power management system. The method includes receiving, by a processor, a request to provide electrical power to a rechargeable device and determining, by the processor, a set of charging parameters responsive to the request, the set of charging parameters indicating a length of time over which to provide the requested electrical power and an amount of electrical power to provide. The method further includes identifying, by the processor, an electrical resource available for a block of time compatible with the set of charging parameters, the identified electrical resource including a branch from a set of branches, each branch configured to selectively provide power from a power supply to one or more rechargeable devices responsive to control instructions from the processor; and issuing, by the processor, one or more control instructions to route electrical power from the power supply via the identified electrical resource to the rechargeable device during the block of time responsive to the request.

In some implementations of the method, the request specifies a charge value. The method can include identifying, from the charge value, a minimum length of time needed at a first electrical current level. In some such implementations, the charge value is a battery capacity percentage. In some implementations, the electrical resource available has a maximum available electrical current level lower than the first electrical current level, and the method includes identifying a second electrical resource available for a second block of time compatible with the set of charging parameters. In some implementations, the method includes detecting a charge value based on one or more signals from the rechargeable device, and identifying, from the detected charge value, a minimum length of time needed at a first electrical current level.

In some implementations, the method includes evaluating the request to determine whether the request can be fully satisfied; placing the request in a queue responsive to determining that the request cannot be fully satisfied; periodically reevaluating one or more requests in the queue; and removing the request from the queue responsive to determining that the request can be satisfied. In some implementations, the method includes reordering the queue.

In some implementations of the method, the set of charging parameters indicates an anticipated disconnect time representing a point in time by which the request should be satisfied. In some implementations, the rechargeable device includes an electric vehicle charger.

In some implementations of the method, the rechargeable device is a first battery charger in a plurality of battery chargers, and the method includes: maintaining one or more data structures with data representative of the plurality of battery chargers, the data indicating a respective set of charging parameters for each respective battery charger in the plurality of battery chargers; generating a graph comprising node data and edge data, the node data including a first set of nodes representing the plurality of battery chargers and a second set of nodes representing power supply resources each capable of providing power to one or more battery chargers in the plurality of battery chargers, and the edge data including a set of edges each linking a first respective node from the first set of nodes to a second respective node from the second set of nodes; identifying a set of paths through the graph, each path including: a first node from the first set of nodes, a second node from the second set of nodes, and an edge from the set of edges; determine, based on the set of paths through the graph, an allocation of power from the power supply resources to one or more of the plurality of battery chargers, wherein the allocation provides a minimum power level to the first battery charger; and issuing one or more control instructions to route electrical power from the power supply to the battery charger in accordance with the determined allocation.

In some aspects, the disclosure relates to a non-transitory computer-readable medium storing instructions that, when executed by a processor, cause the processor to: receive a request to provide electrical power to a rechargeable device including a rechargeable battery; determine a set of charging parameters responsive to the request, the set of charging parameters indicating a length of time over which to provide the requested electrical power and an amount of electrical power to provide; identify an electrical resource available for a block of time compatible with the set of charging parameters, the identified electrical resource including a branch in the set of branches; and issue one or more control instructions to route electrical power from the power supply via the identified electrical resource to the rechargeable device during the block of time responsive to the request.

### BRIEF DESCRIPTION OF THE FIGURES

The above and related objects, features, and advantages of the present disclosure will be more fully understood by reference to the following detailed description, when taken in conjunction with the accompanying figures.

FIG. 1, referred to herein as FIG. 1, is a line drawing of an example charging station environment.

FIG. 2A, referred to herein as FIG. 2A, is a wireframe line drawing of an example queuing electric vehicle charger system.

FIG. 2B, referred to herein as FIG. 2B, is a wireframe line drawing of an example queuing electric vehicle charger system that includes an add-on power management system.

FIG. 3, referred to herein as FIG. 3, is a flowchart for a method of charging multiple rechargeable devices at a charging station.

FIG. 4, referred to herein as FIG. 4, is a flowchart for a method of allocating resources.

FIG. 5A, referred to herein as FIG. 5A, depicts a flowchart of a method for establishing a charging queue for multiple electric vehicles at an EV charging station.

FIG. 5B, referred to herein as FIG. 5B, depicts a flowchart of a method for adding a user to a charging queue for multiple electric vehicles.

FIG. 5C, referred to herein as FIG. 5C, depicts a flowchart of a method for allocating time to a user of a charging station.

FIG. 6, referred to herein as FIG. 6, is a flowchart of a method of deferring requests that cannot be immediately satisfied.

FIG. 7, referred to herein as FIG. 7, is an implementation of an electrical diagram of a charging unit.

FIG. 8A and FIG. 8B, referred to herein respectively as FIG. 8A and FIG. 8B, depict layouts of an electrical diagram of a power line select device.

FIG. 9, referred to herein as FIG. 9, is a block diagram illustrating a general architecture for a computer system that may be employed to implement various elements of the systems and methods described herein, in accordance with an illustrative implementation.

For purposes of clarity, not every component may be labeled in every figure. The drawings are not intended to be drawn to scale. Like reference numbers and designations in the various figures indicate like elements.

### DETAILED DESCRIPTION

A charging station is a device or facility that provides power supply access for charging one or more rechargeable devices. In some implementations, the devices to be recharged are batteries. In some implementations, the devices include a battery charger. In some implementations, the devices need to be connected to a battery charger. In general, a battery charger facilitates transfer of power from a power supply to charging terminals on a battery or cell. A battery charger may include additional circuitry for controlling, conditioning, or otherwise matching electrical input to the charging requirements for a particular rechargeable battery. Likewise, a battery charger may simply be a connection point from an external power supply directly to the battery. The charging station may be provisioned with limited resources, e.g., a charging station for electric vehicles might only be able to charge one or two vehicles at a time.

The battery charger interface may include one or more couplers for connecting a. rechargeable device, e.g., a battery or a device containing a battery, to the charging station. Couplers in a charging station can be contact-based conductive couplers or induction-based wireless couplers. For example, an electric vehicle (EV) charging station may include one or more couplers adhering to an interoperability standards, e.g., the Society of Automotive Engineers (SAE) standard “SAE J1772” for connecting electric vehicles to the EV charging station.

Electrical power flows from a power source through the charging station to a rechargeable device via a coupler (wired or wireless). The amount of power that flows to the coupler may be measured in joules per second, also known as a watt. The amount of power that a rechargeable battery (or device containing the battery) draws from the charging station is a function of the amperage of electrical current available and the voltage for an electric potential of the charging circuit. This is represented by the formula P=I*V, where P is the power (in watts), I is the current (in amperes) and V is the voltage (in volts). The rate at which the battery charges is dependent on the available power. For example, if the amperage of the electrical current is increased, then the battery may charge faster. However, there is a limit to the available amperage of electrical current in a charging station. Accordingly, if there is more demand on the station than available amperage, the demand cannot be fully satisfied.

Power management systems and methods are used to charge batteries and battery systems over an allotted period of time. Many of the examples presented relate specifically to electric vehicle (EV) charging; however, the disclosure is not limited to EV charging. Power management is applicable in many other contexts, including, for example, charging mobile telephones, medical devices, and wearable electronics.

In some implementations, a charger has the ability to charge a certain number of devices (e.g., electric vehicles) by the end of an allotted period of time. Multiple vehicles are attached via standard plugs to a unit that provides electrical connection and communication with a central control system. The number or amount of vehicles can depend on the modular nature of the charging system. The system will input energy simultaneously to a number of vehicles determined by the predefined electrical capacity of the system. At the point when one vehicle is charged to a requested level, the vehicle's charging unit will disengage charging upon command and the charging unit of the next vehicle in the queue will, having received a signal to do so, connect to the power lines and commence charging the new vehicle. This allows for fully charged vehicles to remain in the same parking spot without preventing other vehicles from obtaining charge and therefore reduces the logistical complexity and increases the capacity of an electric vehicle charging system.

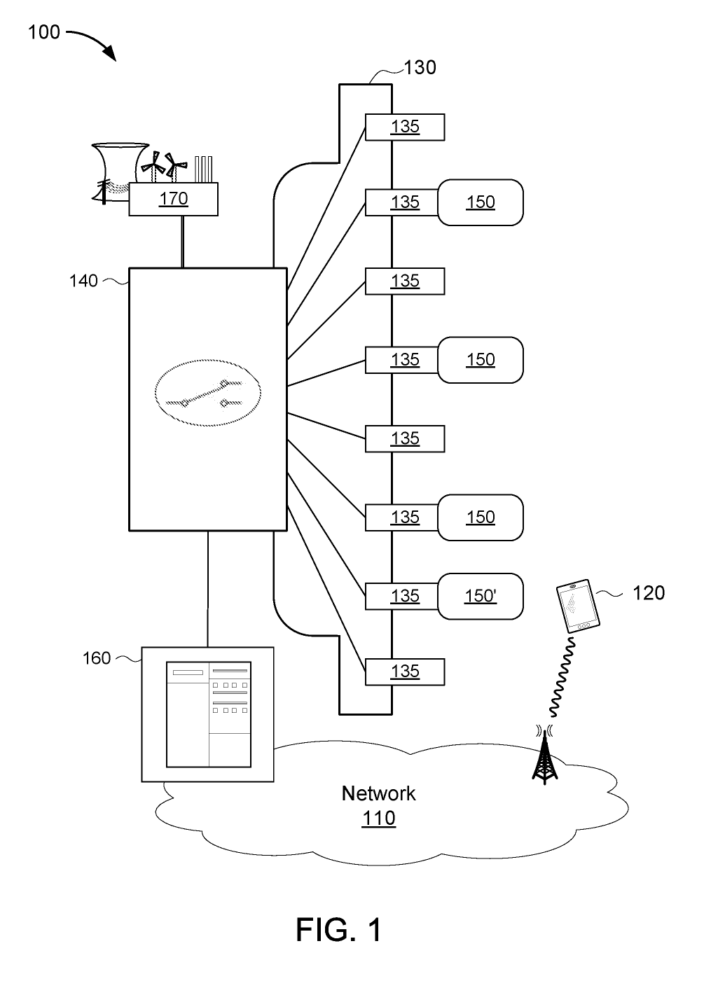

FIG. 1 is a line drawing of an example charging station environment 100. The illustrated environment 100 includes a network for communicating with a client device 120, a charging platform 130 with multiple connection points 135, some of which are shown connected to chargeable devices 150. The charging platform 130 includes a power routing component 140, connecting links from a power supply 170 to branches to the various connection points 135. The charging platform 130, including the power routing component 140, is controlled by a controller 160. In some implementations, the controller 160 is integrated into the charging platform 130, and in some implementations, the controller 160 is distinct from the charging platform 130. For example, in some implementations, the charging platform 130 is controlled from a remote controller 160 situated in the network 110 (e.g., on a cloud computing platform). The illustrated environment 100 enables a client device 120 to submit, via the network 110, to the remote controller 160, a request to charge a device 150′ at the charging platform 130.

Referring to FIG. 1 in more detail, the illustrated example charging station environment 100 includes a charging platform 130. The charging platform 130 facilitates access to electrical power for recharging batteries. In some implementations, the charging platform 130 is a surface where rechargeable devices 150 may be placed for recharging. In some implementations, the charging platform 130 includes conduit for power lines, e.g., cords that can be connected to the rechargeable devices. In some implementations, the charging platform 130 includes an interface or control panel where a user can input a charging request.

The charging platform 130 includes multiple connection points 135. A rechargeable device 150 receives power from the power routing component 140 via a connection point 135. In some implementations, a connection point 135 is a battery charger powered from the power supply 170. In some implementations, a connection point 135 is a coupler for connecting to a rechargeable device 150. In some implementations, the connection points 135 transfer power using contact-based conductive couplers. For example, in some implementations, a connection point 135 is a power outlet. In some implementations, a connection points 135 includes a cord and a plug. In some implementations, the connection points 135 transfer power using induction-based wireless couplers. For example, in some implementations, a connection point 135 is a wireless power transmitter, e.g., a coil embedded in the charging platform 130 that can induce a current inside a rechargeable device. In some implementations, a connection point 135 is compliant with an interoperability standard, e.g., SAE J1772 or the Universal Serial Bus (USB) Power Delivery standard.

The rechargeable devices 150 are removable from the charging platform 130. In some implementations, the rechargeable devices 150 are batteries. In some implementations, the rechargeable devices 150 are electronic devices that include rechargeable batteries. In some implementations, the rechargeable devices 150 include battery charging circuitry that regulates the flow of electrical power from an external power source to an internal battery. In some implementations, this battery charging circuitry cuts off the flow of power to the internal battery when the battery is at or near capacity. In some implementations, this battery charging circuitry propagates a signal to connection point 135 when the internal battery is at or near capacity. Examples of rechargeable devices 150 include, but are not limited to, rechargeable batteries, mobile (cellular) telephones, laptops, tablets, electronic toys, wearable electronics, medical devices, intradermal or subcutaneous devices recharged percutaneously, power tools, portable electrical appliances, electrical vehicles, remote controlled aircraft (e.g., drones), and other portable electronics.

The rechargeable devices 1:50 draw electrical power from the connection points 135. The electrical power originates from a power supply 170. In some implementations of a charging station environment 100, the power supply 170 is local, e.g., a battery source, a chemical fuel cell, a photovoltaic cell such as a solar cell, or a petroleum-derivative-fuel-based generator such as a diesel-based or propane-based generator. In some implementations of a charging station environment 100, the power supply 170 is one or more remote power generators feeding an electrical grid. In some implementations, the electrical grid supplies electricity to the charging station environment 100 at a first voltage level and a transformer converts the electricity to a second voltage level. In some such implementations, the transformer may be considered part of the power supply 170.

The power routing component 140 routes electricity from the power supply 170 to the connection points 135. In some implementations, the power routing component 140 only routes power to a subset of the connection points 135. For example, in some implementations, a series of power relays or switches are used to physically control which connection points 135 are connected to the power supply 170 at any given moment. In some implementations, the power routing component 140 includes relays that can be configured or controlled via instructions from the controller 160. In some implementations, the controllable relays are housed in a single structure, while in other implementations controllable relays are distributed across multiple structures. For example, in some implementations, there is a controllable relay at each connection point 135. Although distributed, such controllable relays are part of the power routing component 140. A connection point 135 that is connected to the power supply 170 by the power routing component 140 is said to be “hot.” In some implementations, the potential load on the charging station environment 100 (e.g., when all connection points 135 are coupled to rechargeable devices 150) exceeds the rated load capacity of one or more elements in the charging station environment 100. Accordingly, the power routing component 140 limits the number of connection points 135 that are hot at the same time.

The power routing component 140 is controlled by a controller 160. The controller 160 signals the power routing component 140 to control which connection points 135 are hot. In some implementations, the controller 160 controls individual power relays or switches within the power routing component 140. In some implementations, the controller 160 is implemented using special-purpose logic circuitry, e.g., an application specific integrated circuit (“ASIC”). In some implementations, the controller 160 is logic circuitry local to the charging platform 130 and the power routing component 140. In some implementations, the controller 160 is remote from the charging platform 130 and the power routing component 140, and communicates with the power routing component 140 via a network link (e.g., via the network 110). In some implementations, the controller 160 includes a computer processor configured to execute instructions for controlling the power routing component 140.

In some implementations, the controller 160 allows a user to schedule recharging for a particular rechargeable device 150′. The user interacts with an interface to indicate parameters for the scheduled recharging. In some implementations, the interface is a panel or set of controls communicatively coupled to the charging platform 130. In some implementations, the interface is provided via the network 110 to a client device 120. In some implementations, the client device 120 is a personal device controlled by the user that presents the interface to the user. In some implementations, the user interacts with the interface to indicate parameters such as a desired charge level (e.g., 80% capacity, full capacity, minimum usage time, minimum drive range, etc.), a desired disconnect time (i.e., the time at which the user expects to be able to remove the device with at least the requested charge level, which may be phrased as a count-down in minutes or hours, or as a specific time, e.g., by noon), and a description of the rechargeable device 150 or a description of the rechargeable device's 150 power requirements (e.g., expected voltage, minimum amperage, etc.). These parameters establish a set of criteria for recharging the rechargeable device 150. In some implementations, the request specifies all necessary charging criteria. In some implementations, the charging criteria specified in the request is augmented with additional criteria determined separately. For example, the maximum electrical input for particular rechargeable devices may be known to the controller 160 and the request may simply identify the device; the controller 160 then looks up the appropriate charging criteria for the identified device. In some implementations, the controller 160 hosts a server-side for an interface presented at a client device 120. In some implementations, a separate server hosts the server-side for an interface presented at a client device 120, e.g., a cloud-based server in the network 110.

In some implementations, the client device 120 submits data to the controller 160 via the interface. For example, the data submitted can include a request to charge a rechargeable device 150 and specify parameters for the request. In some implementations, the client device 120 submits this data to the controller 160 via the network 110. In some such implementations, the client device 120 submits the data to one or more intermediary devices in the network 110. In some implementations, the client device 120 submits data using a direct radio link, e.g., implementing a BLUETOOTH protocol or Near-Field Communications (NFC) protocol. In some implementations, the rechargeable device 150′ provides information out of band from the client device 120. For example, in some implementations, the rechargeable device 150′ includes a radio frequency identification (RFID) chip and the charging platform 130 includes an MID chip reader; when powered by the RFID chip reader, the RFID chip broadcasts information about the rechargeable device 150′ for receipt by the RFID chip reader, which then conveys this information to the controller 160. In some such implementations, the data provided by the client device 120 is augmented with the information gleaned from the rechargeable device 150, e.g., from an RFID chip.

The network 110 is a data communication network, e.g., the Internet. The network 110 may be composed of multiple networks, which may each be any of a local-area network (LAN), such as a corporate intranet, a metropolitan area network (MAN), a wide area network (WAN), an inter-network such as the Internet, or a peer-to-peer network, e.g., an ad hoc WiFi peer-to-peer network. The data links between devices may be any combination of wired links (e.g., liber optic, mesh, coaxial, twisted-pair such as Cat-5, etc.) and/or wireless links (e.g., radio, satellite, or microwave based). The network 110 may include public, private, or any combination of public and private networks. The network 110 may be any type and/or form of data network and/or communication network. In some implementations, data flows through the network 110 from a source node to a destination node as a flow of data packets, e.g., in the form of data packets in accordance with the Open Systems Interconnection (“OSI”) layers, e.g., using an Internet Protocol (IP) such as IPv4 or IPv6. A flow of packets may use, for example, an OSI layer-4 transport protocol such as the User Datagram Protocol (UDP), the Transmission Control Protocol (“TCP”), or the Stream Control Transmission Protocol (“SCTP”), transmitted via the network 110 layered over IP.

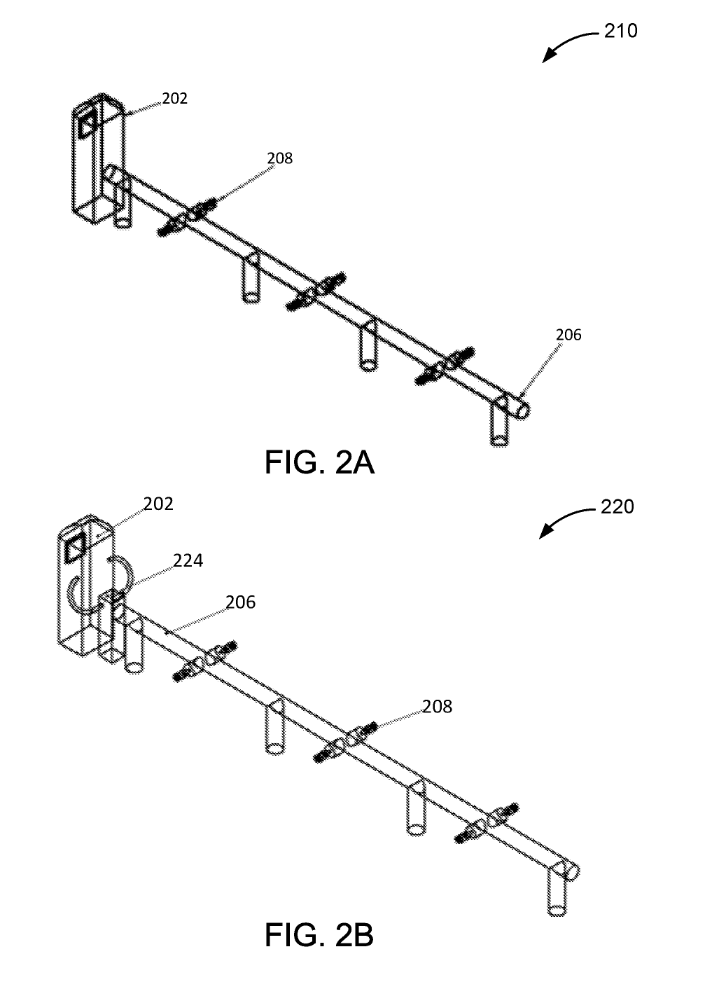

100441 The example charging station environment 100 illustrated in FIG. 1 may be implemented in a variety of contexts. For example, it may be implemented in a hospital or clinic setting for recharging biomedical devices, it may be implemented in a commercial setting for recharging mobile personal devices (e.g., phones and tablets), or it may be implemented in an outdoor setting for recharging mobile electronic appliances such as boats or electric vehicles. In some implementations, as shown in FIGS. 2A and 2B, an existing charging device can be augmented to result in an equivalent to the example charging station environment 100.

FIG. 2A is a wireframe line drawing of an example queuing electric vehicle charger system 210. The illustrated queuing electric vehicle charger system 210 includes an electric charger 202, modular electric cable storage conduit 206, and connection points 208. The queuing electric vehicle charger system 210 directs power from the electric charger 202 to the connection points 208 via cables held within the modular electric cable storage conduit 206. An electric vehicle positioned along the queuing electric vehicle charger system 210 can be connected to the queuing electric vehicle charger system 210 at a connection point 208 to obtain electrical power from the queuing electric vehicle charger system 210. In some implementations, the electric charger 202 is designed to charge a small number (e.g., 1 or 2) of vehicles and the modular electric cable storage conduit 206 and connection points 208 are add-ons to the electric charger 202, expanding its linkage capacity to a larger number of vehicles (i.e., more than the initial 1 or 2, e.g., 6). However, because the electric charger 202 may not be meant to concurrently support the larger number of vehicles, the arrangement illustrated in FIG. 2A may benefit from an additional power management system.

FIG. 2B is a wireframe line drawing of an example queuing electric vehicle charger system 220 that includes an add-on power management system 224. The queuing electric vehicle charger system 220 includes the electric charger 202, modular electric cable storage conduit 206, and connection points 208, previously described in reference to FIG. 2A. The queuing electric vehicle charger system 220 shown in FIG. 2B directs power from the electric charger 202 to the connection points 208 via the add-on power management system 224 and the cables held within the modular electric cable storage conduit 206. An electric vehicle positioned along the queuing electric vehicle charger system 220 can be connected to the queuing electric vehicle charger system 220 at a connection point 208 to obtain electrical power from the queuing electric vehicle charger system 220. In some implementations, the electric charger 202 is designed to charge a small number (e.g., 1 or 2) of vehicles and the modular electric cable storage conduit 206 and connection points 208 are add-ons to the electric charger 202, expanding its linkage capacity to a larger number of vehicles (i.e., more than the initial 1 or 2, e.g., 6). The add-on power management system 224 regulates the demand on the electric charger 202 such that, from the perspective of the electric charger 202, the number of electric vehicles connected to the electric charger 202 at any given time is within the load capacity of the electric charger 202. This add on configuration allows safe expansion of the electric charger 202 and is one example of the benefits of electric charging power management.

The power management system 224 is connected to the electric charger 202 and uses the electric charger 202 as a power supply to feed power to branch lines within the modular electric cable storage conduit 206. In some implementations, the power management system 224 uses relays to route power from the electric charger 202 to one or more specific connection points 208. In some implementations, the power management system 224 is controlled by a logic circuitry that determines which connection points 208 to power at any given time. In some implementations, the power management system 224 is controlled by a computer processor executing software that determines which connection points 208 to power at any given time. In some implementations, the power management system 224 is controlled remotely, e.g., via a network connection.

The example queuing electric vehicle charger systems 210 and 220 respectively shown in FIGS. 2A and 2B are example implementations of the charging station environment 100 illustrated in FIG. 1. In sonic implementations, the connection points 208 are comparable to the connection points 135 illustrated in FIG. 1. In some implementations, the electric cable storage conduit 206 is comparable to the charging platform 130 illustrated in FIG. 1. In some implementations, the power management system 224 is comparable to the power routing component 140 illustrated in FIG. 1. In some implementations, the power management system 224 includes a controller comparable to the controller 160 illustrated in FIG. 1. In some implementations, the electric charger 202 is comparable to the power supply 170 illustrated in FIG. 1. This comparison is an example, and is not a limitation.

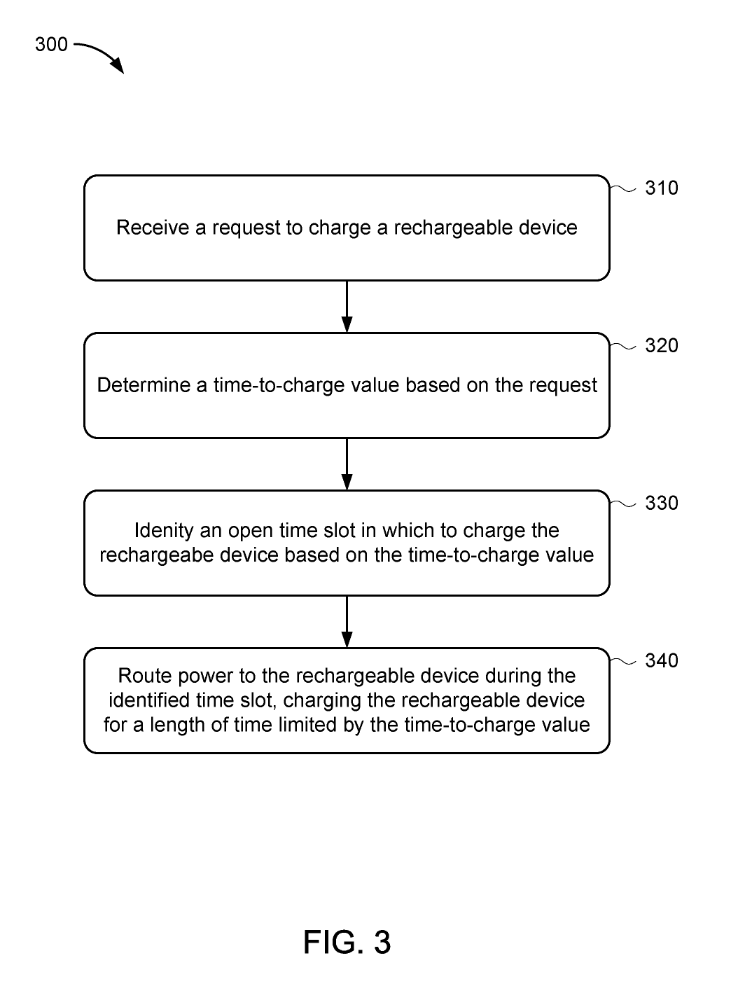

FIG. 3 is a flowchart for a method 300 of charging multiple rechargeable devices at a charging station. Referring to FIG. 3 in broad overview, at stage 310, a controller for the charging station receives a request to charge a rechargeable device (e.g., an electric vehicle). At stage 320, the controller determines a time-to-charge value based on the request. The time-to-charge value represents an amount of time needed to satisfy the request at a particular power level. At stage 330, the controller identifies an open time slot in which to charge the rechargeable device based on the time-to-charge value. At stage 340, the controller routes power to the rechargeable device during the identified time slot, charging the rechargeable device for a length of time limited by the time-to-charge value. For example, referring to FIG. 1, the request may be sent from the client device 120 to the controller 160 to charge the rechargeable device 150′, and the controller 160 may satisfy the request by issuing instructions to the power routing component 140 to route power from the power supply 170 through the platform 130 to the appropriate connection point 135 to charge the rechargeable device 150′ during a time slot identified in stage 330.

Referring to FIG. 3 in more detail, at stage 310, a controller (e.g., controller 160) for the charging station receives a request to charge a rechargeable device (e.g., rechargeable device 150, such as an electric vehicle). The request is submitted by a user via a control interface. For example, in some implementations, the request is submitted via a client device 120. The request is a request to provide electrical power to the rechargeable device 150. The request may indicate a set of charging parameters specific to the rechargeable device 150. For example, the charging station may be for electric vehicles and may include multiple spaces or charging spots to accommodate a plurality of vehicles. A user can drive an electric vehicle (EV) into an open parking space and submit a request to charge the vehicle. In some such implementations, the request identifies the parking space, the vehicle type, and an anticipated departure time. In some implementations, the request identifies a desired charge level and the controller 160 provides an estimated ready time, which can then be accepted or rejected by the user. The ready time can be used to establish the anticipated departure time in stage 320.

In some implementations, the user interacts with a control interface communicatively coupled to the charging station to submit the request. In some implementations, the control interface is a software application executing on a computing device that is a component of the charging station. For example, the charging station may include one or more kiosks or user interface devices to provide a display for a user at the charging station. In some implementations, the control interface is remotely located from the charging station and communicatively coupled to the charging station. The charging station stores received request information in a database accessible to the interface, e.g., hosted by a database management system (DBMS) executing on a computer device coupled to the control interface or a DBMS executing on a remote server that is communicatively coupled to the control interface, e.g., via a network. In some implementations, the database stores information from every past request.

At stage 320, the controller determines a time-to-charge value based on the request. The time-to-charge value represents an amount of time needed to satisfy the request at a particular power level. The controller determines a time-to-charge value for the electric vehicle based on the request. In some implementations, the request may include a charge value indicating an amount of electricity needed to satisfy the request. In some implementations, the charge value is a percentage of battery capacity. In some implementations, the controller determines an initial charge level of a battery, e.g., by measuring battery strength or querying a rechargeable device, and the charge value defaults to an amount of energy needed to bring the battery to full capacity. In some implementations, a user may specify a charge value that is for less than full capacity. For example, a user might only need to charge an electric vehicle to 50% so that the user can drive home.

The controller uses the charge value, and the charging characteristics of the rechargeable device 150 to determine how long it will take to charge the device. In some implementations, the time-to-charge value is estimated as the amount of electrical energy needed divided by the maximum rate that electrical energy can be provided. The maximum rate that electrical energy can be provided is the lowest maximum rate capability for the elements used to deliver power from the power supply to the battery. In some instances, the lowest maximum rate capability may be associated with the rechargeable device 150 itself. In some instances, the lowest maximum rate capability may be associated with an element of the charging station.

However, the rate at which some batteries charge is non-linear. As some batteries approach a full charge, the battery may charge more slowly. Each battery may have a different characteristic inflection point in its corresponding killowatt/time vs percentage-charged graph. In some implementations, the charging station uses ammeter circuitry to detect when a rechargeable battery has begun to throttle back charging. This can indicate that the battery is at or near capacity. In some implementations, the controller 160 estimates the time-to-charge value to account for these characteristics.

At stage 330, the controller identifies an open time slot in which to charge the rechargeable device based on the time-to-charge value. In some implementations, a scheduler identifies one or more available time slots that, in the aggregate, constitute a sufficient length of time to satisfy the charge request. In some implementations, the scheduler uses one or more of the specific methods for identifying and allocating time slots described in more detail further herein. In some implementations, the scheduler implements a maximum flow algorithm such as Ford-Fulkerson, Edmonds-Karp, preflow-push, or push-relabel to optimize flow through the described network of nodes and edges. The flows through the edges are then used to select time allocation to each end point. If the time slots to be allocated end prior to the desired departure time, the allocation may be considered satisfactory. In some implementations, the controller 160 notifies a user, e.g., via the interface, that the charging station can (or cannot) satisfy the request. In some implementations, the controller 160 notifies a user, e.g., via the interface, of a predicted completion time based on the time slot allocation. In some implementations, if a user is unsatisfied, the user can modify or cancel the charging request.

In some implementations, the charging system identifies an open time slot in a queue list based on the time-to-charge value. In some implementations, the controller 160 prioritizes providing a charge to the rechargeable device 150 with the shortest time to leave deadline, provided that all other requests can be satisfied within their respective time to leave deadlines. If a user submits a request for a charge within a timeframe that cannot be met, the controller 160 may offer a next-best completion time based on delaying any queued charges that can be delayed and still fulfilled within the deadline, but queueing the request after all other requests that cannot be delayed without missing their respective deadlines. In some implementations, the controller 160 may offer or identify alternative charging locations that do have capacity to satisfy the request requirements.

In some implementations, when the charging station can no longer accept additional rechargeable devices while meeting all charge request deadlines, the controller 160 can enter into a ‘high capacity’ mode. where the vehicles can be charged in their highest energy transfer region. Because each vehicle may have a different characteristic inflection point its kilowatt/time vs percentage-charged graph, the charging station can use ammeter circuitry to detect when a rechargeable device 150 has begun to throttle back charging, and switch to the next rechargeable device 150 in the queue. When the controller 160 reaches a state where all deadlines can be met, the rechargeable devices 150 can then be further charged. In some implementations, the controller 160 may detect that a rechargeable device 150 has passed its inflection point, e.g., using the ammeter circuitry, and revisit the allocation of resources for charging the rechargeable device 150. This can decrease the allocation reserved for the rechargeable device 150 that is almost charged. As a result, more resources are then available to be allocated to other rechargeable devices 150 in the queue.

In some implementations, a charging request includes a priority value such that requests may be allocated time slots based on a corresponding priority. In some implementations, some requests may be deprioritized (and not fully satisfied) in order to satisfy a higher priority request. In some such implementations, a user may request to improve an unsatisfactory ready time by bumping a lower priority request. A request may be prioritized, for example, based on a user's priority status. For example, an installation at a building may allow tenants of the building to be prioritized over visitors, or vice versa. In some implementations, a service subscriber may have an option to pay a higher subscription fee for a higher priority level, or a frequent user may build loyalty points that can be used to prioritize a charge. In some implementations, a user wishing to improve an unsatisfactory ready time can pay a one-time fee. In some such implementations, a portion of the fee is paid to the person whose request is bumped. In some implementations, a user may request that his or her request have a low priority in the hopes of being bumped and receiving a payment.

In some implementations, a priority value may be based on a ranking or weight assigned to a user account, or based on a behavior history associated with the user. In some such implementations, the controller, or an account manager, maintains a rating score for a user and adjusts the rating score to reward or discourage various predefined behaviors. The account manager can dynamically (e.g., real time) modify rating score based on user behaviors. For example, the account manager may upgrade or increase a rating score when a user connects a rechargeable device within a small window of time around a scheduled arrival time, when the user removes the rechargeable device within a small window of time around a scheduled disconnect time, when the user authorizes a reduced priority (increasing scheduling flexibility for the scheduler), or agrees to modify properties of a charging request so that other charging requests can be satisfied. Likewise, the account manager may downgrade or decrease a rating score to discourage behaviors that impede the ability of the charging system to function properly. For example, the rating score may be decreased for missing or showing up late for a charging appointment. In some implementations, users with a higher rating score are prioritized over user with lower rating scores. This can thus reward desired user behavior.

At stage 340, the controller 160 routes power to the rechargeable device 150 during the identified time slot, charging the rechargeable device for a length of time limited by the time-to-charge value. In some implementations, the controller 160 issues instructions or activates relays to reconfigure the power routing component 140 to route power from the power supply 170 through the platform 130 to the appropriate connection points 135, according to the schedule.

In some implementations, the controller enables users to plan for upcoming travel. For example, where the charging station is an electric vehicle charging station, a user could plan to arrive at the charging station and request to reserve a recharge time slot. In some implementations, a user can submit request to set up charging appointments for multiple different locations along a trip route prior to departing on the trip (or while in route). The requests may be received minutes, hours, days, or weeks before arrival.

In some implementations, the interface includes various maps and lists of all EV charging stations. A user can enter a starting location and an intended destination, and the interface can indicate the locations of various EV charging stations along a route (or alternative routes) between the starting location and the destination. The user can enter requested areas or rank areas based on a desired route to get to the destination. In some implementations, the interface indicates availability at the EV charging stations along the route(s), e.g., indicating open slots near expected arrival times or indicating expected wait times at different charging stations. In some implementations, the availability indications are based on a current state of the various EV charging stations. In some implementations, the availability indications are based on a predicted state of the various EV charging stations, e.g., based on historic analytics for utilization at an anticipated charging time.

In some implementations, the interface enables a user to enter, e.g., as a list of places or ‘pins’ on a digital map, a desired route the user intends to travel. In some implementations, a user can enter routinely used routes, e.g., a daily commute. A user could do this, for example, when setting up an account with an account profile. In some implementations, the system can collects statistics for the user as the user travels a routine route, e.g., measuring an average trip time and which EV charging stations the user visited. The average trip route can be saved in the user's account profile and be accessible to the user. In some implementations, the controller may use a Global Navigation Satellite System (GNSS) receiver, e.g., GPS, to identify the location of an EV and identify which EV charging stations have been visited. In some implementations, the system monitors a user's daily driving via the GNSS receiver and, using various machine learning algorithms, improves the quality of predictions for when and where the user will need to recharge. This can improve scheduling time slots for the user at EV charging stations along the user's typical routes.

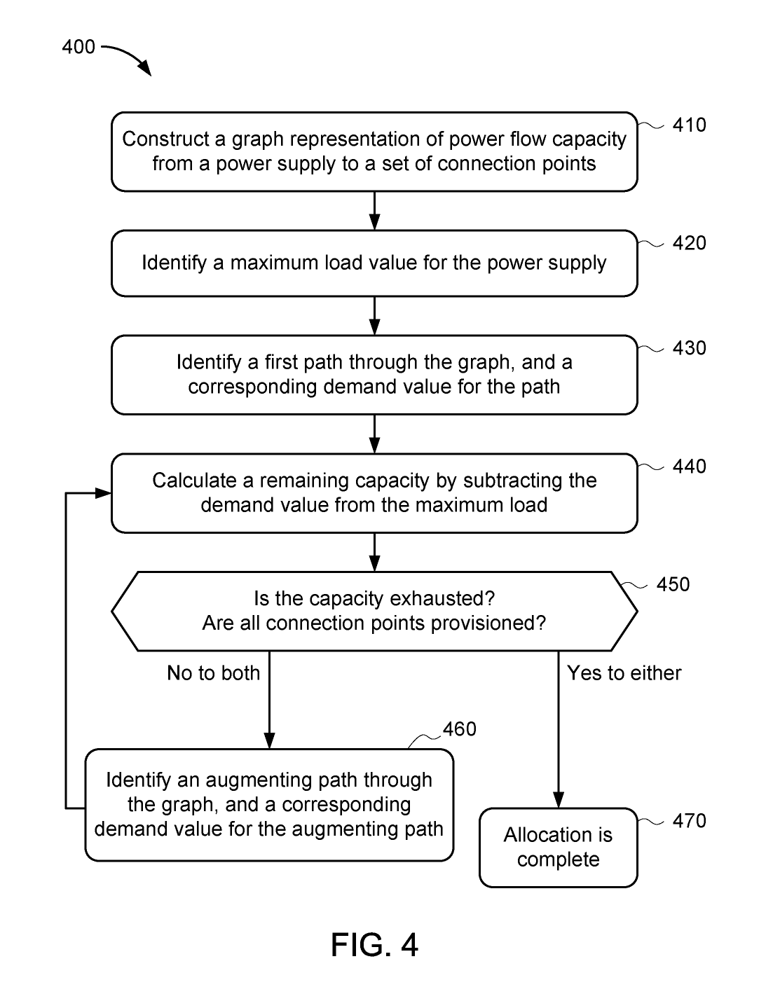

FIG. 4 is a flowchart for a method 400 of allocating resources. In some implementations, a scheduler, e.g., the controller 160, identifies the resources and requests for a given window of time (a time slot). In some implementations, the time slots are fixed periods, e.g., every twenty minutes. In some implementations, the time slots are dynamic windows of time beginning and ending with change events (e.g., a new device needing to be charged or a device being removed). For each time slot, the scheduler allocates resources according to the method 400. In broad overview of the method 400, at stage 410, the scheduler constructs a graph representation of power flow capacity from a power supply to a set of connection points 135. At stage 420, the scheduler identifies a maximum load value for the power supply. At stage 430, the scheduler identifies a first path through the graph, and a corresponding demand value for the path. At stage 440, the scheduler calculates a remaining capacity be subtracting the demand value from the maximum load. At stage 450, the scheduler determines if the capacity has been exhausted and/or if all connection points 135 are provisioned. If the capacity has not been exhausted and at least one connection point 135 has not been provisioned, then at stage 460 the controller identifies an augmenting path through the graph, and a corresponding demand value for the augmenting path. The scheduler then returns to stage 440 and recalculates the remaining capacity. If, at stage 450, the scheduler determines if that the capacity has been exhausted or that all connection points 135 are provisioned, then allocation is complete at stage 470.

Referring to FIG. 4 in more detail: At stage 410, the scheduler constructs a graph representation of power flow capacity from a power supply to a set of connection points 135. A graph representation is a data structure (or set of data structures) representing nodes linked together by edges.

In some implementations, the scheduler generates a graph in which each connection point 135 is a terminal node linked to a resource node. Each resource node is either a power supply or a link to another node. Accordingly, there is a path (or a plurality of paths) from a power supply node through zero or more intermediary nodes terminating at a node representing a connection point 135. In some implementations, some of the nodes represent charging stations. In some implementations, some of the nodes represent relays that can selectively connect power from a source link to a branch.

In some implementations, the scheduler generates a list of all times when rechargable devices become available for charge and unavailable for charge. It then generates three sets of nodes: A first set of nodes representing rechargable devices to be recharged; a second set of nodes representing rechargable devices able to be charged in a particular time period; and a third set of nodes represents power sources (power supplies or links to power supplies) available in the particular time periods. The graph connects a terminal source node with an available edge to a node from the first set, where an edge is available if its utilization is below capacity. Each node in the first set is connected to corresponding nodes in the second set according to predetermined or possible device charger pairings with edges capacitated by the amount of charging required by the rechargable device. Nodes in the second set are connected to nodes in the third set according to which power source(s) the charges are physically connected with edges capacitated by the amount of charging able to be accomplished by the charger in the time period in question. The nodes in the third set are connected with a terminal sink node with edges capacitated by the amount of power or energy able to be provided by the source in question in the time period in question.

In some implementations, each link is rated for a maximum power load, e.g., a maximum amperage that a line can physically handle. In some implementations, the graph representation includes weights or values to represent the capacity of each link. In some implementations, the graph is stored in computer memory and only constructed when there is a topology change. In some implementations, the graph is constructed on demand. In some such implementations, the graph only includes connection points 135 that have a demand load (or an anticipated demand load), e.g., connection points 135 that have rechargeable device 150 attached.

At stage 420, the scheduler identifies a maximum load value for the power supply 170. In some implementations, the maximum load cannot be exceeded without risk of fire or damage to the charging equipment. In some implementations, the charging platform simply cannot draw more power than the maximum load value.

At stage 430, the scheduler identifies a first path through the graph, and a corresponding demand value for the path. The first path is a sequence of nodes (and edges or links) representing physical equipment through which power can flow from the power supply 170 to a connection point 135.

At stage 440, the scheduler calculates a remaining capacity by subtracting the demand value from the maximum load. Each element of the path has a corresponding maximum power capacity. For example, a power line in the path might be rated for significantly lower amperage than the incoming power link from the power supply 170. A path cannot carry more power than its weakest element. Accordingly, the scheduler determines a maximum load for the identified path. If the maximum load is sufficient to fully satisfy criteria for charging a device 150 at the corresponding connect point 135, then the connection point 135 is considered fully provisioned. If not, then an additional augmenting path to the connection point may be provisioned. Once a resource is utilized at full capacity, it cannot be further utilized. In some implementations, the scheduler updates the graph representation with offsets for the demand of the identified path.

At stage 450, the scheduler determines if the capacity has been exhausted and/or if all connection points 135 are provisioned. The scheduler analyses the allocation and determines whether additional resources can or need to be allocated. If the maximum load value for the power supply is fully utilized, then no more power can be allocated. Likewise, if the intermediary resources are at fully capacity, such that no additional paths can be formed to the connection points 135, then no more power can be allocated. Additionally, if all of the connection points 135 are provisioned such that all charging requests can be satisfied, there is no need to allocate additional resources.

If the capacity has not been exhausted and at least one connection point 135 has not been provisioned, then at stage 460 the controller identifies an augmenting path through the graph, and a corresponding demand value for the augmenting path. In some implementations, the scheduler uses a maximum flow algorithm such as Ford-Fulkerson, Edmonds-Karp, preflow-push, or push-relabel to identify an augmenting path. In some implementations, the scheduler identifies a highest priority connection point 135 and identifies an augmenting path to the identified highest priority connection point 135. In some implementations, the scheduler identifies an under-provisioned connection point 135 and identifies an augmenting path to the identified under-provisioned connection point 135. The scheduler then returns to stage 440 and recalculates the remaining capacity based on additionally allocating resources to the identified augmenting path. The loop through stages 440, 450, and 460 is repeated as needed.

At stage 450, if the scheduler determines if that the capacity has been exhausted or that all connection points 135 are provisioned, then allocation is complete at stage 470. In some implementations, the scheduler identifies the allocation and a controller 160 then issues instructions to a power routing component 140 to implement the allocation, actually provisioning the power. In some implementations, the controller 160 issues the instructions to the power routing component 140 to implement the allocation as the scheduler determines the allocation. In some implementations, the controller 160 waits until stage 470 to issue the instructions. In some implementations, the scheduler is implemented in or with the controller 160. In some implementations, the scheduler is a separate component. For example, in some implementations, the scheduler is implemented in logic hosted in the network 110.

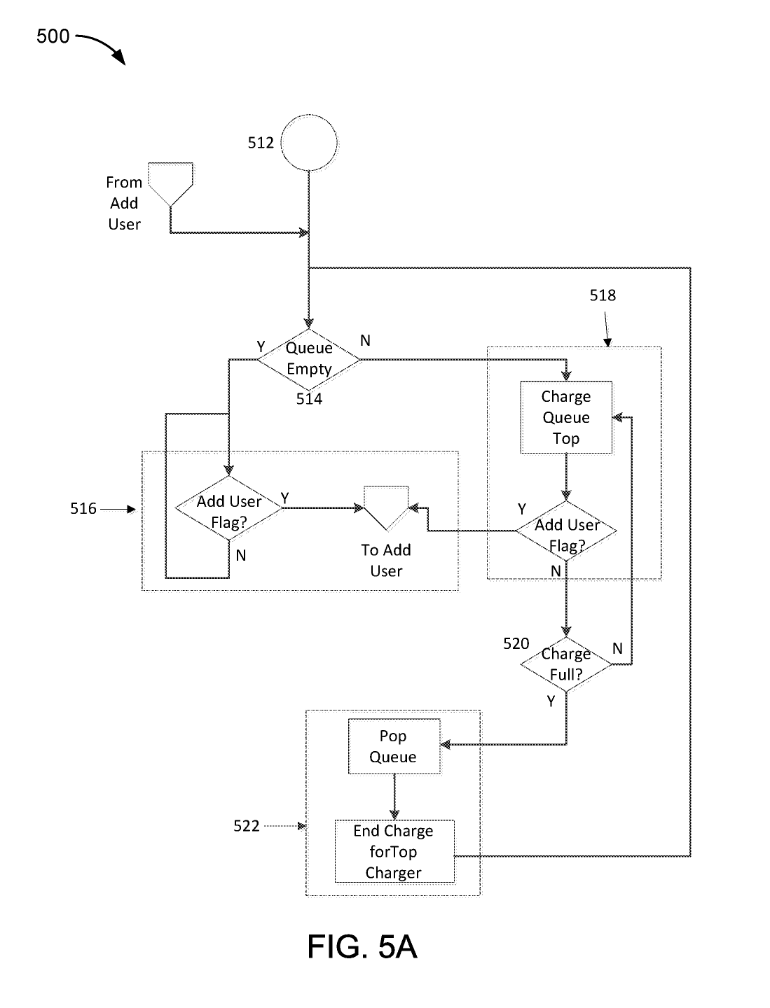

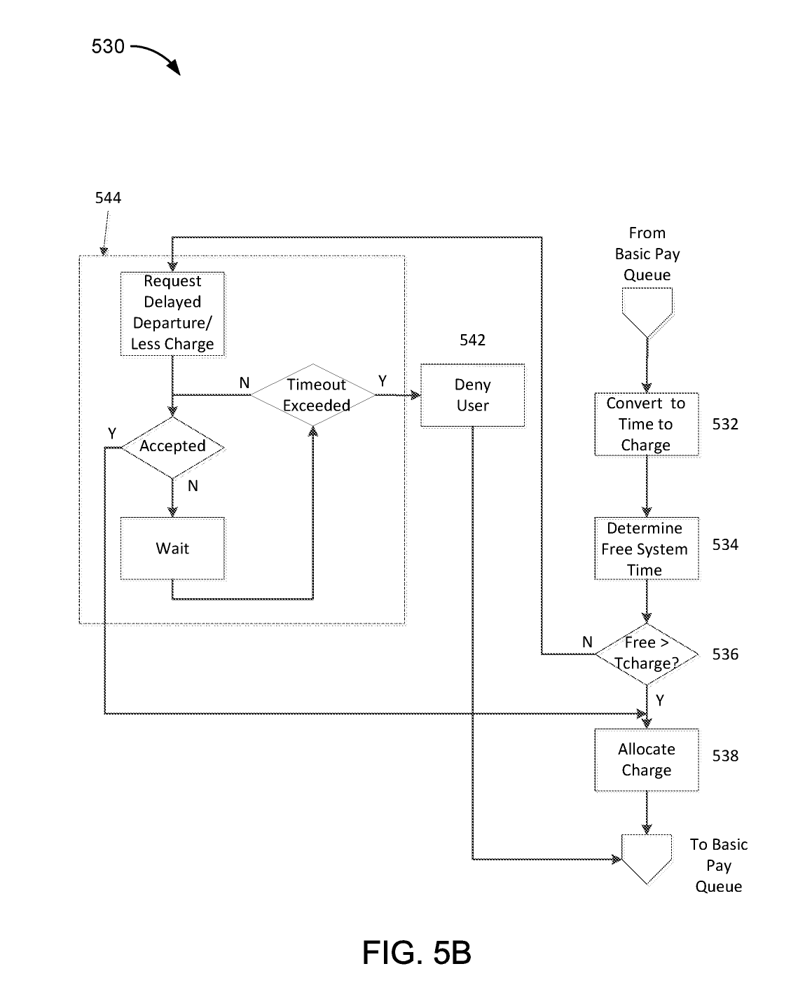

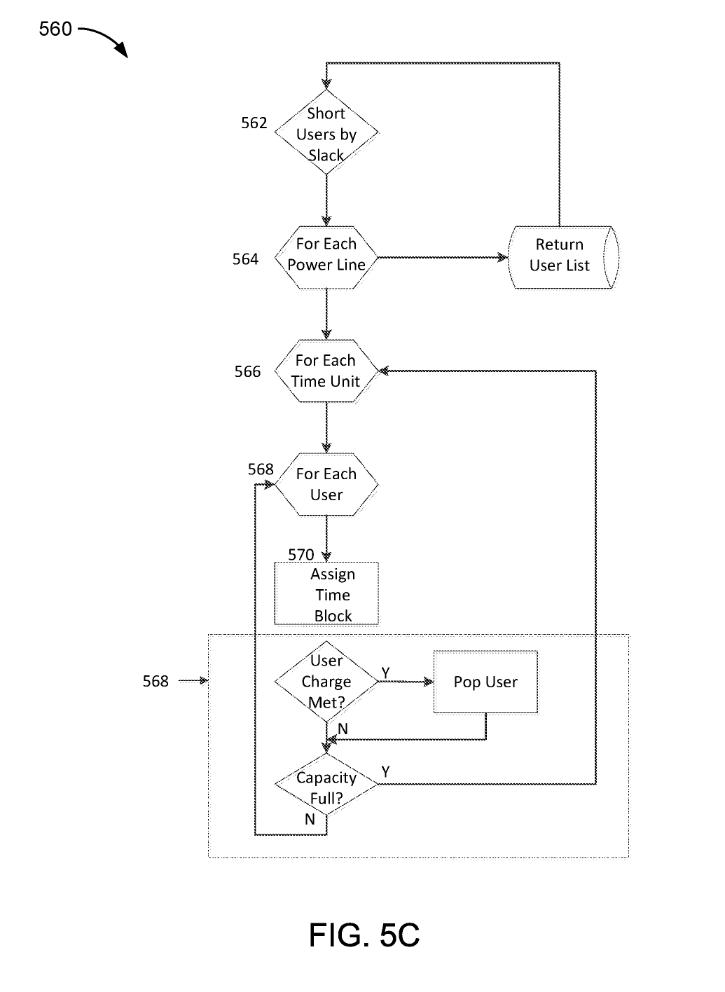

FIGS. 5A, 5B, and 5C depict flow diagrams for methods of maintaining a charging queue for electric vehicles. While these examples are directed to charging an electric vehicle (EV), the subject matter disclosed is also applicable to charging other rechargeable devices. These are example implementations.

FIGS. 5A is a flowchart of a method 500 for establishing a charging queue for multiple electric vehicles at a charging station. Referring to FIG. 5A in broad overview, at stage 512, the controller receives a request to charge an electric vehicle. At stage 514, the controller determines if the charging queue is empty. If the charging queue is empty, then at stage 516 the controller adds the request to the queue. At stage 518, if the charging queue is not empty, the controller identifies the top vehicle in the charging queue by analyzing the priority list. At stage 410, once the top vehicle has been identified, the controller determines if the top vehicle's charge has been fulfilled. If the charge of the top vehicle has been fulfilled, at stage 412, the controller ends the charge for the top vehicle and updates the priority list.

Referring to FIG. 5A in more detail, at stage 512, the controller receives a request to charge an electric vehicle. A user may submit the request via a computing device, such as a handheld computing device. The request may include a charge value and a time value. The charge value may indicate a desired charge amount and the time value may indicate a desired departure time, or a time between an expected arrival time and the desired departure time. In some implementations, the controller receives the request when the user is at the charging station. In other implementations, the controller receives the request from a location remote from the charging station, such as while the user is at home or on the road.

At stage 514, the controller determines if the charging queue is open or available for the new user. The charging queue may be open if no other vehicles are connected to the charging station. In some implementations, the charging queue is open if the connected vehicles, not including the vehicle making the request, have finished charging. If the charging queue is open, the controller can update a user flag to indicate the user is charging and the add the user to the charging queue. The controller maintains a current list of all of the currently charging vehicles connected to the charging queue.

In some implementations, the vehicles on the list can be ranked or weighted and slotted into a priority list based on the ranking or the weight value they are assigned. The ranking or weight value may be based on user characteristics, the charge value requested, the time value constraints, vehicle characteristics. In some implementations, the vehicles on the list can be ranked or weighted and slotted into a priority list based on the ranking or the weight value they are assigned. The ranking or weight value may be based on user characteristics, the charge value requested, the time value constraints, vehicle characteristics. In some implementations, controller may provide privileged or VIP accounts for users (e.g., priority levels as presented above). The VIP accounts can increase a user's weight value in determining their priority when making a request in comparison to another user. In other implementations, the controller may provide a limited privilege status, such as for creating a new user account or an existing user account reaching a service threshold. The user's accounts privilege or priority level may be increased for a specified number of charging appointments as a reward for continued business. In some implementations, a privilege or priority level may be based on a ranking or weight assigned to a user account, or based on a behavior history associated with the user. In some such implementations, the controller, or an account manager, maintains a rating score for a user and adjusts the rating score to reward or discourage various predefined behaviors, as presented above.

In some implementations, the controller or an administrator of the controller can create categories for user accounts. The categories can be binary, integer values scalar, or continuously valued scalar. The controller may group or sort into one or more of the categories and generate a ranking or weight to each user accounts based on which categories the user account is associated. For example, the categories may be based on characteristics of the user (e.g., demographic data, age, gender, driving record, location, seniority of user in organization etc.), characteristics of a vehicle associated with the user account (e.g., model, type, year, etc.), or historical data of the user account (e.g., travel history, charging history, etc.). In some implementations, the charging station may be located at an office building or corporation parking lot and the categories may be based on a position or organization group within the corporation. For example, the user characteristics may be based on a title or position of the employee, or a specific group the employee works in.

At stage 518, if the charging queue is not open, the controller identifies the top vehicle in the charging queue by analyzing the priority list. In some implementations, the top vehicle is the vehicle currently being charged by the charging system.

At stage 520, once the top vehicle has been identified, the controller can determine if the top vehicle's charge has been fulfilled. A charge can be considered fulfilled when it is complete or when it has reached an acceptable level. The acceptable level can be determined based on the values received with the charging request. In some implementations, the acceptable is determined as when the ammeter at the charging stations detects the EV has begun to throttle back charging. In other implementations, the acceptable level can be determined based on the values received with the charging request. For example, the user may enter a range of charge values to indicate acceptable levels of charging that may be less than a full or complete charge for the vehicle. The controller may determine that a charge is fulfilled based on a threshold or percentage complete value. For example, predetermined thresholds and percentages may be established to indicate when a vehicle has received enough of a charge and the controller can stop charging that vehicle and begin charging a vehicle with a lower priority value on the priority list. If the charge is not fulfilled, the process may return to stage 518 and repeat stages 518 and 410 until the charge has been fulfilled.

If the charge of the top vehicle has been fulfilled, at stage 522, the controller ends the charge for the top vehicle and updates the priority list. The priority list may be updated to move the top vehicle to the bottom of the list or off of the list or to a new priority level within the list. The updated priority list may now identify a new top vehicle to be charged. The method then returns to stage 514 to determine if the queue is empty. The queue can be considered empty if all of the other vehicles, not including the requesting vehicle, have had their charges fulfilled to an acceptable level or if the requesting vehicle is now at the top of the priority list (e.g., the top vehicle). At stage 516, if the charging queue is empty, the controller adds the user to the queue list.

FIG. 5B is a flowchart of a method 530 for adding a user to a charging queue for multiple electric vehicles. At stage 532, the controller converts the charge value to a time-to-charge value. The charge value can be received in the initial charge request from the user. In some implementations, the controller determines how long, (i.e. for how many discrete time units) to charge the vehicle, and how much electrical current to allow it to draw for those time units using the charge value. In some implementations, the controller uses the following equations:

∫Pdt=E

P=V×1

Where P is power, V is a voltage, I is current and E is an energy value. The controller converts the power into units that it can allocate, such as time and current. For example, the voltage (V) can be a constant defined for the controller, and the current (I) can be selected from an available current in a given time segment. Next, the controller can use the summation of discrete units of time to approximate integration in Riemann's method.

In some implementations, the charge value can either be a percentage charged value or an energy value. The controller can use the vehicle characteristics to convert a percentage into the energy value. The energy can then be divided by smaller values of either the maximum current the vehicle accepts of the maximum available current for the system. The result can then be divided by the voltage, such as 240V or 208V, to produce a time needed to charge the respective vehicle.

At stage 534, the controller determines free system time from the time of the request to the departure time or final time value indicated in the request received from the user. To determine the free system time, the controller compares each minute from the time the request is received to the total time required (e.g., departure time of vehicle). For example, the controller may compare the time values using the following formula:

Total required time<minute (i)−now (time request is received)

The controller may then add minutes as long as the count continues to increase. When the count increases stop, the controller can treat it as a separate charge queue entity and continue search. For example, if a new user needs 30 minutes of charge and there's a 20 minute break between scheduled times for existing users that cannot be rearranged, the new user can be scheduled for those 20 minutes and then for 10 minutes later.

At stage 536, the controller compares the free system time to the total time required to charge (T_{free}>T_{tocharge}). If the T_{free} is greater that the T_{tocharge}, at stage 538, the controller allocates the requested charge time to the user's vehicle. The controller may sort or update the priority list based on the allocated time. In some implementations, the priority list is made up of all user's requesting a charge based on the leave time. For example, the priority list may indicate when each user will be begin and stop charging based on their leave time. Once the time has been allocated to the appropriate user, method returns to stage 514 of FIG. 5A.

If the T_{free} i s less than the T_{tocharge}, at stage 542, the controller may deny the user's request for a charge until more time is available and the method returns to stage 514. In some implementations, the controller may indicate to the user that the time available is not sufficient to meet their charge request. In some implementations, at stage 544, the controller may offer a later departure time or request the user provide a later departure time. In some implementations, the controller determines if a new user will fit into the current queue list based on the requested times. The controller will continue to search until it finds enough capacity to offer the requested charge. Once enough capacity has been identified, the controller reports back with a message to the user (or user's client device), such as “you can receive X charge by your departure time, or the requested charge by Y time.” The user is provide an option to keep the original departure time, or to accept the delayed time. In some implementations, the controller may offer to provide a smaller charge value than indicated in the charge request. The controller may also query other charging stations or systems in the same ecosystem (i.e. another nearby lot or deck) and inform the user that another nearby lot can accommodate their needs. In other implementations, the controller may search for a predetermined time limit before indicating to the user that sufficient time is not available for their current request.

The controller may wait for a predetermined time period (e.g., from about 30 seconds to about 5 minutes) for the user to accept or reject the offers. If the user accepts the later departure time or the smaller charge value, the method may return to stage 538 and the corresponding time may be allocated to the user. If the user rejects the later departure time or the smaller charge value, the controller can wait until the predetermined time period runs out to provide the user a chance to change their mind. Once the predetermined period has run out, the controller can deny the user's request for a charge and transmit a response to the user indicating the rejection.

Now referring to FIG. 5C, a flowchart method 560 for allocating time for charging electric vehicles at a charging station is shown. At stage 562, the controller may sort users requesting a charge by slack time, from least slack time to most slack time. The controller may determine a slack time for each user requesting a charge and compare them to sort or generate a charge list or priority list. In an implementation, slack time is the departure time of the vehicle subtracted by the charge value over the max charged rate (e.g., T_{depature}−(charge value/max charged rate)).

At stage 564, for each power line. At stage 566, for each time unit from the time of the request to the departure time or max time. At stage 568, the controller determines a slack time for each of the users requesting to be charged. The slack can be defined for each user for each charging request or appointment. In some implementations, the slack indicates how much time a user has until they need to leave minus the amount of time the system needs to give them their charge. In an implementation, the slack time is how much time the system can let the user's vehicle sit idle, without charging and without failing to give them their requested charge.

At stage 570, the controller assigns time blocks to each of the users requesting to be charged. In some implementations, the controller determines a rate for each of the user's respective vehicles to be charged. For example, the controller may determine an amperage to charge a vehicle, such as a max amperage or an available amperage amount. In some implementations, the controller can use the slack time to first schedule “critical” (e.g., no room for delay) users prior to other users. Critical users may be assigned a ranking or weight value higher than other users. In some implementations, critical users can be provided a maximum charge rate, where the maximum charge rate is time they need to charge based on maximum possible current.

In some implementations, a customer will submit a request to charge a rechargeable device that cannot be immediately satisfied. However, it is possible that the request could be later satisfied. The customer might be seeking to reserve a charging timeslot, or might leave a rechargeable device with the charging platform, in the hopes that the request is eventually satisfied.

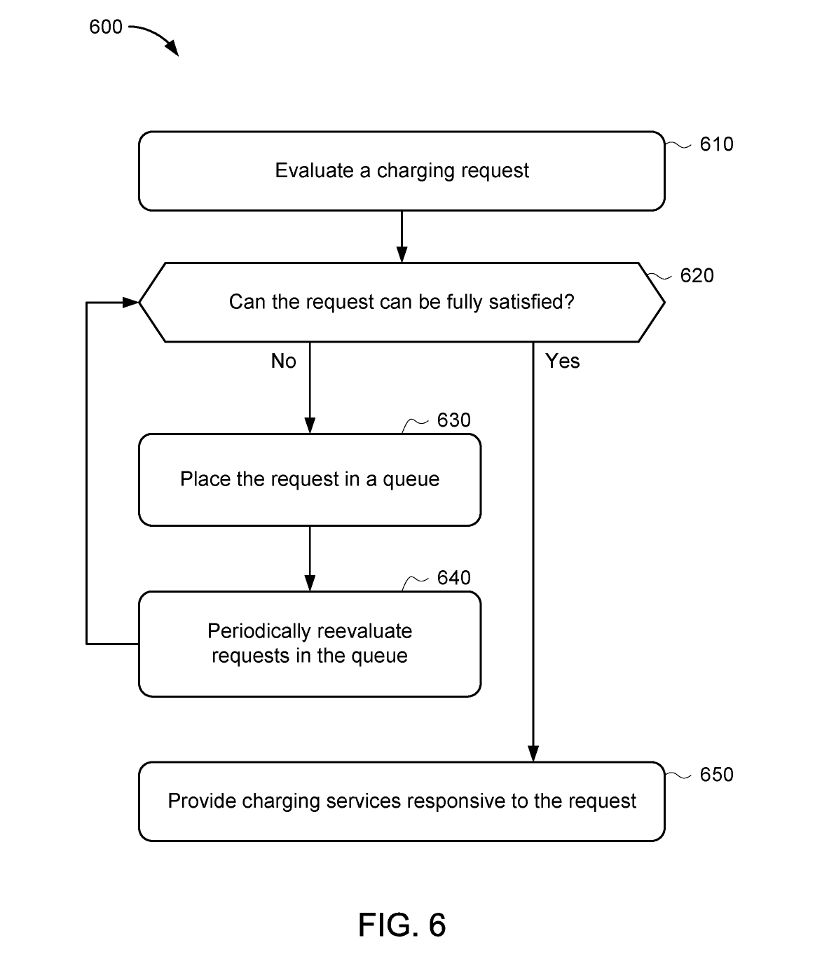

FIG. 6 is a flowchart of a method 600 of deferring requests that cannot be immediately satisfied. In broad overview, at stage 610, a scheduler evaluates a charging request to determine, at decision stage 620, whether the request can be satisfied. If the request cannot be immediately satisfied, then at stage 630 the request is placed in a queue. Periodically, at stage 640, the scheduler reevaluates one or more requests in the queue, returning to decision stage 620. If the request can be satisfied, then at stage 650 the scheduler schedules charging services to be provided responsive to the charging request.

Referring to FIG. 6 in more detail, at stage 610, a scheduler evaluates a charging request to determine, at decision stage 620, whether the request can be satisfied. In some implementations, the charging request includes one or more criteria. For example, the request may be to charge the rechargeable device with at least a minimum amperage level. As another example, the request may be to charge a battery to full capacity. In some implementations, the request may include a completion deadline. In some implementations, the request may be a request to schedule a time slot. In some such implementations, the request may be to schedule the next available time slot, or the next available time slot during certain windows of time.

At decision stage 620, the scheduler determines whether the request can be satisfied. If the request requires resources that are unavailable, it cannot be satisfied. In some implementations, the request can be partially satisfied but not fully satisfied. For example, there may be an open time slot during which the rechargeable device could be partially charged, but not fully charged. In some implementations, a request that can be partially satisfied is split into two requests, such that one of the two requests cannot be satisfied; the satisfiable request is then handled at stage 650 and the other is treated as a request that cannot be immediately satisfied.

If the request cannot be immediately satisfied, then at stage 630 the request is placed in a queue. In some implementations, the queue is a first in/first out ordered list. In some implementations, the queue is a data structure holding information representative of the request(s), e.g., an ordered set. In some implementations, the scheduler pushes a request to the end of the queue. In some implementations, the scheduler inserts a request into the queue based on one or more factors, e.g., a priority associated with the request, a deadline associated with the request, a resource allocation needed to satisfy the request, etc. In some implementations, a request may be added anywhere in the queue, even at the front ahead of previously queued requests.

Periodically, at stage 640, the scheduler reevaluates one or more requests in the queue, returning to decision stage 620. In some implementations, the scheduler reevaluates the first request in the queue to see if it can be satisfied. If so, the request is removed from the queue and handled at stage 650. This may then repeated until the request at the head of the queue cannot be immediately satisfied. In some implementations, the scheduler continues to reevaluate requests past the first request at the head of the queue, even if the request at the head of the queue cannot be immediately satisfied. In some implementations, the entire queue is reevaluated. In some implementations, the scheduler reevaluates one or more requests in the queue at regular intervals, e.g., every few minutes (such as every two minutes, every five minutes, etc.) In some implementations, the scheduler reevaluates requests in the queue responsive to a change event. For example, the scheduler may reevaluate requests in the queue when a new request is received, when a request has been fully satisfied, when a rechargeable device is fully charged, or when a rechargeable device is removed. In some implementations, the scheduler constantly reevaluates requests in the queue.

In some implementations, the request is placed in a queue and the customer can influence the request's position in the queue, e.g., by having a priority status, by paying a fee, by using loyalty points, by agreeing to take an action such as watching an advertisement, and so forth. In some implementations, the queue is occasionally or periodically re-ordered. For example, in some implementations, when the scheduler reevaluates requests during stage 640, the order of the requests in the queue may be modified.

If the request can be satisfied, then at stage 650 the scheduler schedules charging services to be provided responsive to the charging request. In some implementations, the scheduler, or a controller, causes power to flow to the rechargeable device so that the request can be satisfied. In some implementations, the scheduler notifies the customer that the request can now be satisfied. For example, in some implementations, the scheduler causes an e-mail or SMS message to be sent to a client device 120.

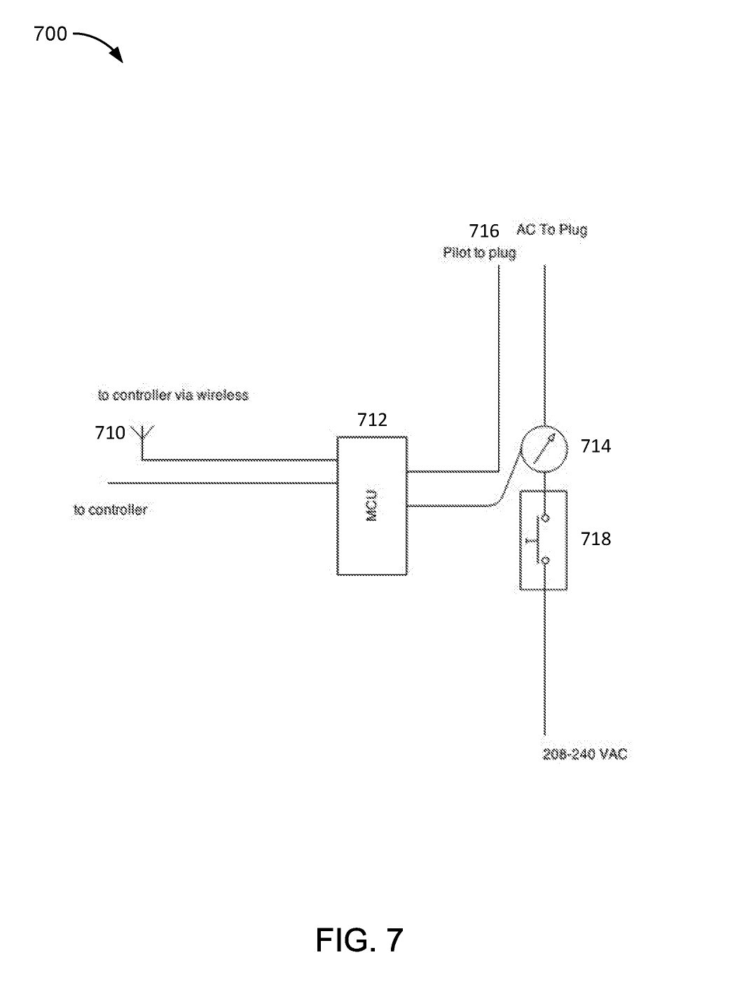

Now referring to FIG. 7, an electrical diagram of a charging unit 700 is shown. In an implementation, the electrical diagram is a “plug box” topology, an alternative to the topology as shown in FIGS. 1, 2A, and 2B. The plug box 700 includes a microcontroller (MCU) 712, an ammeter 714, a wire 716 to provide for communication between the EV and the charger (plug box 700), and a power select device 718 (e.g., relay system) for selecting power lines.

Each plug box 700 can connect to a central control system 710, through various communications protocols, such as through Ethernet, 1-wire, Wi-Fi, ZigBee, or any other wireless or wired communication protocol. In some implementations, the central control system 710 is a communication system to communicate with the plug box 700. The central control system 710 can be coupled to the plug box 700 via either a wired or wireless connection. The central control system 710 can send commands to engage charging and indicate what amperage the electric vehicle should draw. In some implementations, the MCU 712 can instruct the electric vehicle to draw power at the indicated amperage level via the J1772 pilot protocol 716. The MCU 712, in response to commands from the central control system 710, can generate a pilot signal and activate the power select device 718 to connect to the appropriate EV. While charging takes place, the MCU 712 periodically reads the ammeter 714 and supplies ammeter data to the central control system 710. In some implementations, the MCU 712 reads the ammeter 714 continuously.

In some implementations, the central control system 710 is a logical circuit. In some implementations, the central control system 710 is a computer system configured to execute instructions to control the plug box 700. In some such implementations, the central control system 710 is located remotely from the plug box 700 and issues commands or instructions to the plug box 700 to control it remotely. In such implementations, the central control system 710 may be communicate with the plug box 700 via a network, e.g., the Internet. In some implementations, the central control system 710 is hosted in a computing cloud. In some implementations, the MCU 712 implements an instruction set or application programmer interface (API) that the central control system 710 uses to control the plug box 700.

In some implementations, the MCU 712 is a microcontroller with a real time or near real time operating system. The MCU 712 can include a pulse-width-modulator (PWM) output generator and an analog-to-digital converter. The PWM output generator can output appropriate signals for communicating with the central control system 710. In some implementations, the components of the MCU 712 can be separate components functioning together as an embedded system. For example, the analog to digital converter and the PWM output generator may be on separate chips but wired together with a microcontroller.

In some implementations, the transfer of power can be accomplished through means other than a plug, including induction based wireless systems, RF based wireless systems, microwave based systems, or any other means of physical interconnection or non-interconnected transmission of energy. The charging unit 700 may deliver power at various levels dependent upon the vehicle to be charged and timing or charging parameters indicated in the charging request. For example, the charging system 700 may provide and deliver actual power at various levels, such as a level 1, level 2, or level 3 charge. The level 1 charging may be a SAE 1772 level 1 charging using 120 volt lines. The level 2 charge may be a SAE 1772 level 2 charging using 220, 240, or 208 volt lines. The level 3 charge may be a SAE 1772 level 3 charging using DC power, e.g., for electric busses. In some implementations, the level 3 charge is the CHADEMO standard level 3 charging using DC power. In some implementations, for the level 3 charge, the charging system 700 may include power electronics such as rectifiers and power conditioners that may be placed either topologically before or within the charging system 700 as described above.

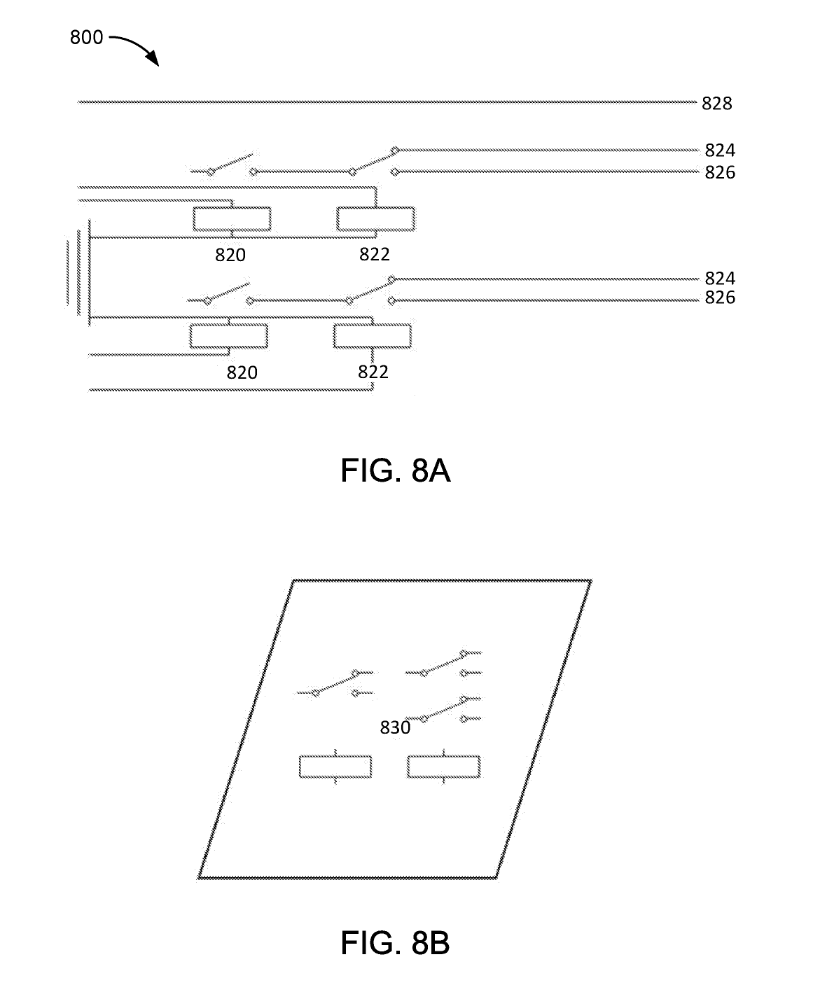

Now referring to FIGS. 8A-8B, electrical diagrams of a power line select device 800 are shown. The power select device may be similar to and operate the same or similar to the power select device 718 depicted in FIG. 7. In some implementations, the electrical diagram of the power select system 800 allows the system to draw from any number of separate power lines. The power select device 800 can include throw relays 820, double throw relays 822, a first power line 824, a second power 826, and a ground wire 828. The throw relays 820 can be a coil of a dual pole, single throw power relay, or contactor used as the final step of connection and to turn on and off the charge to a EV. In some implementations, during the last step, the throw relays may endure arcing and can have robust contacts rated for the arcing. The double throw relays can be a coil of a dual pole, dual throw relay, or contactor that enables the device to draw from 2 available power lines. The first power line 824 and the second power line 826 can, in the case of level 2 charging, be either 208-volt or 240-volt power lines, or the power lines and neutral line of the same. The ground wire 828 can be a ground line or ground line and neutral line tied to ground, common to both available lines. The first power line 824 and second power line 826 may, in the case of level one charging, be 120-volt power and neutral lines, respectively. The system may also use similar topologies to distribute level 3 charging standards or any future charging standards.

Now referring to FIG. 8A, which depicts a two-line layout of the power select device 800. The first set of single pin, single throw relays 820 are power rated and always connect last to complete the circuit. The single pin, double throw relays 822 provide the ability to connect to either a power line 824, or a second power line 826. Ground wires 28 are always connected. FIG. 8B depicts an example extension 830 of the system. Any number of extensions 830 can be used to allow an arbitrary number of connections by building a tree out of a (n/2)pdt relays connected to a (n/4)pdt relay and so on to a spdt relay. By controlling the coils of all of these relays, the MCU can select any of n power lines to which to connect. FIG. 8B depicts a an example of how to double or increase the available lines by two-times. The system may also be implemented using triodes, solid state switches, actuated switches, stepping switches, mosfets, or any other electromechanical, vacuum tube, or solid state devices.

In some implementations, the system, consists of n 240-volt, 3-phase power lines (or any other power source) and n relays, will enable the addition of power lines to be just as effective as the addition of new charging stations. A tree of relays can be formed, to ensure that every plug is connected via a relay to each power line. By turning on and off the relays in series, along with the addition of more than two power lines, the station can charge up to n connected cars at once.

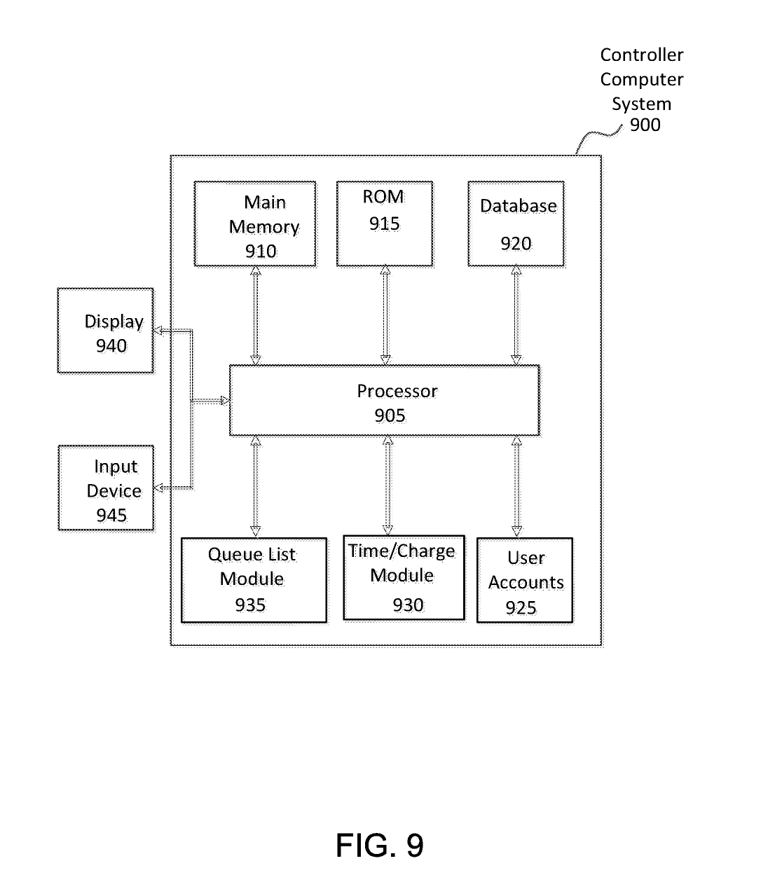

Now referring to FIG. 9, which shows a block diagram of a general architecture for an controller 900 that may be employed to implement various elements of the systems and methods described herein. In some implementations, the controller 900 may be a computer system or a cloud based computing system. The controller may be housed at the charging station as a component of the charging station or may be remotely located from the charging station and executing on a remote computing system or a cloud based server. In some implementations, the controller 900 is communicatively coupled to the systems as described above with respect to FIG. 1, 2, or 7. For example, the controller 900 may be communicatively coupled to the microcontroller (MCU) 12 as described above with respect to FIG. 7. In other implementations, the controller 900 may be part of or a component of the system as described above with respect to FIG. 1, 2, or 7.

In some implementations, the controller computer system 900 may include processor 905, main memory 910, a read only memory (ROM) 915, a database 920, a user account module 925, a time/charge module 930, a queue list module 935, a display 940, and a input device 945. Each of the components or modules of the controller 900 may be configured to perform the various methods as described herein, for example, as described in FIGS. 3-6. In some implementations, some or all of the information received, determined, and/or obtained related to the charging process can be stored in a data structure in the main memory 910 or the database 920. Upon receiving input via the input device 945, the processor 905 can access the data structure stored in main memory 910 and display, execute, perform, or otherwise assess the methods as described herein.

In some implementations, the processor 905 may prompt or otherwise utilize information related to electric vehicle charging. In some implementations, the controller 900 may be configured to receive instructions from a central station or central server. For example and without limitation, an administrator may enter instructions or policies to be implemented on the controller 900 and control the charging process using the central station. In some implementations, the instructions may include a queue list parameters, user account updates, timing and charging calculations updates, or priority list updates.

101121 The controller 900 can include a bus or other communication component for communicating information and the processor 905 (e.g., processing circuit) may be coupled to the bus for processing information received via the input device 945. The controller 900 can also include one or more processors 905 or processing circuits coupled to the bus for processing information. The main memory 910, such as a random access memory (RAM) or other dynamic storage device, can be coupled to the bus for storing information, and instructions to be executed by the processor 905. The main memory 910 can also be used for user information and information related to the charging process, or other intermediate information during execution of instructions by the processor 905. The controller 900 may further include the ROM 915 or other static storage device coupled to the bus for storing static information and instructions for the processor 905. The user accounts module 925 may be at least one of a solid state device, magnetic disk or optical disk, is coupled to the bus for persistently storing information and instructions. In other implementations, the user accounts module 925 is a database, table, or index for creating and storing information related to user accounts.

In some implementations, the controller 900 may be coupled via the bus to a display 940, such as a liquid crystal display, or active matrix display, for displaying information to a user. In one implementation, the display 940 may be an interactive display. For example, the display 940 may be a touchscreen, user interface, or a kiosk. The input device 945 may be a keyboard including alphanumeric and other keys, that may be coupled to the bus for communicating information and command selections to the processor 905. In another implementation, the input device 945 has a touch screen display 940. The input device 945 can include a cursor control, such as a mouse, a trackball, or cursor direction keys, for communicating direction information and command selections to the processor 905 and for controlling cursor movement on the display 945.

According to various implementations, the processes described herein can be implemented by the controller 900 in response to the processor 905 executing an arrangement of instructions contained in the main memory 910. Such instructions can be read into the main memory 910 from another computer-readable medium, such as the database 920. Execution of the arrangement of instructions contained in main memory 715 causes the controller 900 to perform the illustrative processes and methods described herein. One or more processors in a multi-processing arrangement may also be employed to execute the instructions contained in main memory 910 or database 920. In alternative implementations, hard-wired circuitry may be used in place of or in combination with software instructions to effect illustrative implementations. Thus, implementations are not limited to any specific combination of hardware circuitry and software.

Although an example computing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

What is claimed is:

1. A power management system, the system comprising:
a processor configured to execute a set of instructions;
a link to a power supply; and
a set of branches, each branch configured to selectively provide power from the link to one or more rechargeable devices responsive to control from the processor;
wherein the set of instructions, when executed by the processor, cause the processor to:
receive a request to provide electrical power to a rechargeable device including a rechargeable battery;
determine a set of charging parameters responsive to the request, the set of charging parameters indicating a length of time over which to provide the requested electrical power and an amount of electrical power to provide;
identify an electrical resource available for a block of time compatible with the set of charging parameters, the identified electrical resource including a branch in the set of branches; and
issue one or more control instructions to route electrical power from the power supply via the identified electrical resource to the rechargeable device during the block of time responsive to the request.

2. The system of claim 1, wherein the request specifies a charge value, and wherein the set of instructions, when executed by the processor, cause the processor to identify, from the charge value, a minimum length of time needed at a first electrical current level.

3. The system of claim 2, wherein the charge value is a battery capacity percentage.

4. The system of claim 2, wherein the electrical resource available has a maximum available electrical current level lower than the first electrical current level, and wherein the set of instructions, when executed by the processor, cause the processor to identify a second electrical resource available for a second block of time compatible with the set of charging parameters.

5. The system of claim 1, wherein the set of instructions, when executed by the processor, cause the processor to detect a charge value based on one or more signals from the rechargeable device, and identify, from the detected charge value, a minimum length of time needed at a first electrical current level.

6. The system of claim 1, wherein the set of charging parameters indicates an anticipated disconnect time representing a point in time by which the request should be satisfied.

7. The system of claim 1, wherein the rechargeable device includes an electric vehicle charger.

8. The system of claim 1, wherein the set of instructions, when executed by the processor, cause the processor to:
evaluate the request to determine whether the request can be fully satisfied;
place the request in a queue responsive to determining that the request cannot be fully satisfied;
periodically reevaluate one or more requests in the queue; and
remove the request from the queue responsive to determining that the request can be satisfied.

9. The system of claim 8, wherein the set of instructions, when executed by the processor, cause the processor to reorder the queue.

10. The system of claim 1, wherein the rechargeable device is a first battery charger in a plurality of battery chargers, and wherein the set of instructions, when executed by the processor, cause the processor to:
maintain one or more data structures with data representative of the plurality of battery chargers, the data indicating a respective set of charging parameters for each respective battery charger in the plurality of battery chargers;
generate a graph comprising node data and edge data, the node data including a first set of nodes representing the plurality of battery chargers and a second set of nodes representing power supply resources each capable of providing power to one or more battery chargers in the plurality of battery chargers, and the edge data including a set of edges each linking a first respective node from the first set of nodes to a second respective node from the second set of nodes;
identify a set of paths through the graph, each path including: a first node from the first set of nodes, a second node from the second set of nodes, and an edge from the set of edges;
determine, based on the set of paths through the graph, an allocation of power from the power supply resources to one or more of the plurality of battery chargers, wherein the allocation provides a minimum power level to the first battery charger; and
issue the one or more control instructions to route electrical power from the power supply to the battery charger in accordance with the determined allocation.

11. A method of allocating electrical power in a power management system, the method comprising:
receiving, by a processor, a request to provide electrical power to a rechargeable device;
determining, by the processor, a set of charging parameters responsive to the request, the set of charging parameters indicating a length of time over which to provide the requested electrical power and an amount of electrical power to provide;
identifying, by the processor, an electrical resource available for a block of time compatible with the set of charging parameters, the identified electrical resource including a branch from a set of branches, each branch configured to selectively provide power from a power supply to one or more rechargeable devices responsive to control instructions from the processor; and
issuing, by the processor, one or more control instructions to route electrical power from the power supply via the identified electrical resource to the rechargeable device during the block of time responsive to the request.

12. The method of claim 11, wherein the request specifies a charge value, the method further comprising identifying, from the charge value, a minimum length of time needed at a first electrical current level.

13. The method of claim 12, wherein the charge value is a battery capacity percentage.

14. The method of claim 12, wherein the electrical resource available has a maximum available electrical current level lower than the first electrical current level, the method further comprising identifying, by the processor, a second electrical resource available for a second block of time compatible with the set of charging parameters.

15. The method of claim 11, the method comprising detecting a charge value based on one or more signals from the rechargeable device, and identifying, from the detected charge value, a minimum length of time needed at a first electrical current level.

16. The method of claim 11, wherein the set of charging parameters indicates an anticipated disconnect time representing a point in time by which the request should be satisfied.

17. The method of claim 11, wherein the rechargeable device includes an electric vehicle charger.

18. The method of claim 11, the method further comprising:
evaluating the request to determine whether the request can be fully satisfied;
placing the request in a queue responsive to determining that the request cannot be fully satisfied;
periodically reevaluating one or more requests in the queue; and
removing the request from the queue responsive to determining that the request can be satisfied.

19. The method of claim 18, the method further comprising reordering the queue.

20. The method of claim 11, wherein the rechargeable device is a first battery charger in a plurality of battery chargers, the method further comprising:
maintaining one or more data structures with data representative of the plurality of battery chargers, the data indicating a respective set of charging parameters for each respective battery charger in the plurality of battery chargers;
generating a graph comprising node data and edge data, the node data including a first set of nodes representing the plurality of battery chargers and a second set of nodes representing power supply resources each capable of providing power to one or more battery chargers in the plurality of battery chargers, and the edge data including a set of edges each linking a first respective node from the first set of nodes to a second respective node from the second set of nodes;
identifying, by the processor, a set of paths through the graph, each path including: a first node from the first set of nodes, a second node from the second set of nodes, and an edge from the set of edges;
determining, by the processor, based on the set of paths through the graph, an allocation of power from the power supply resources to one or more of the plurality of battery chargers, wherein the allocation provides a minimum power level to the first battery charger; and
issuing, by the processor, the one or more control instructions to route electrical power from the power supply to the battery charger in accordance with the determined allocation.
